(19) United States
(12) Patent Application Publication
(10) Pub. No.: US 2013/0006414 A1
(43) Pub. Date: Jan. 3, 2013

(54) MONEY HANDLING APPARATUS

(76) Inventors: Kenichi TAGASHIRA, Himeji-Shi (JP); Seiji KIYOSE, Himeji-Shi (JP)

(21) Appl. No.: 13/535,408

(22) Filed: Jun. 28, 2012

(30) Foreign Application Priority Data
Jun. 28, 2011 (JP) 2011-143028

(51) Int. Cl. G06F 17/00

(52) U.S. Cl. 700/232

(57) ABSTRACT

A money handling apparatus of an embodiment of the present invention includes a storing unit storing money; a dispensing unit dispensing money; a memory unit storing data of a number of stored money and a reference value; and a control unit controlling the denomination and the number of money to be dispensed. The memory unit is configured to store plural sets of reference numbers which are number of money by denomination as the reference value, or a reference ratio which is a ratio of the number of money by denomination as the reference value. When a certain sum of money is dispensed, the control unit is configured to determine the denomination and the number of money to be dispensed, giving a priority to the denomination whose number of stored money by denomination or money storage ratio is larger than one of the reference numbers or the reference ratio.

### TECHNICAL FIELD

The present invention relates to a money handling apparatus, for example, a money handling apparatus that receives, gives back and store money in cash settlement in a store.

### BACKGROUND ART

In a checkout counter of a store, a money handling apparatus has been conventionally used, in order that a clerk receives money from a customer and gives back money to the customer. The money handling apparatus has a function for recognizing and counting money having been put thereinto so as to calculate a sum of the money, a function for storing the money, and a function for dispensing money stored therein as a change.

In the money handling apparatus, when money is dispensed as a change, the money handling apparatus generally determines a denomination/denominations of money to be dispensed as a change, such that the number of money constituting a change becomes the least, and dispenses money of this/these denomination/denominations as a change. Namely, in general, the money handling apparatus is configured to give back money as a change by dispensing money whose number is the least (money of the least number).

Patent Document 1: 3P2008-198131A

However, in order to compose a change of money of the least number, it is necessary to compose the change of money of large denomination as much as possible, within a range of a sum of money to be dispensed. Thus, when a change of money of the least number is repeatedly given back, money of a specified denomination in the money handling apparatus is frequently used. In this case, in the money handling apparatus, money of the specified denomination is rapidly decreased, so that it is necessary to frequently refill money of the specified denomination. Although refilling of money of another denomination is unnecessary, to perform a refilling operation for only money of the specified denomination is inefficient and uneconomical.

### DISCLOSURE OF THE INVENTION

The present invention has been made in view of the above problem. The object of the present invention is to provide a money handling apparatus that can reduce the number of operations for refilling money by controlling the denomination of money to be dispensed.

A money handling apparatus in one embodiment according to the present invention includes a storing unit configured to store money by denomination and to feed out money stored therein;

a dispensing unit configured to dispense money stored in the storing unit;

a memory unit configured to store data of a number of money of each denomination stored in the storing unit, and a reference value relating to the number of money to be stored for each denomination; and

a control unit configured to control the denomination and the number of money to be dispensed from the dispensing unit;

wherein:

the memory unit is configured to store plural sets of reference numbers which are numbers of money by denomination as the reference value, or a reference ratio which is a ratio of the number of money by denomination as the reference value; and

when a certain sum of money is dispensed, the control unit is configured to determine the denomination and the number of money to be dispensed, giving a priority to the denomination whose number of stored money or money storage ratio is larger than one of the reference numbers or the reference ratio, the money storage ratio being a ratio of stored money of each denomination relative to the numbers of money of a plurality of denominations stored in the storing unit, and

the dispensing unit dispenses the money determined by the control unit.

In this embodiment, the memory unit is configured to store at least a first reference number which is firstly used as the reference value and a second reference number which is used when the number of money stored in the storing unit decreases;

in a case where a certain sum of money is dispensed, when the number of money of the first denomination out of money stored in the storing unit reaches the reference number and the number of money of a smaller denomination whose money value is smaller than the first denomination is larger than the reference number, the control unit is configured to determine the denomination and the number of money to be dispensed, giving a priority to the smaller denomination; and

when the number of money stored in the storing unit satisfies a predetermined condition, the control unit is configured to change the reference value from the first reference number to the second reference number.

The money handling apparatus according to claim 1, wherein:

the memory unit is configured to store the reference number and the reference ratio,

in a case where a certain sum of money is dispensed, when the number of money of the first denomination out of money stored in the storing unit reaches the reference number and the number of money of a smaller denomination whose money value is smaller than the first denomination is larger than the reference number, the control unit is configured to determine the denomination and the number of money to be dispensed, giving a priority to the smaller denomination; and

when the number of money stored in the storing unit satisfies a predetermined condition, the control unit is configured to compare the money storage ratio to the reference ratio before the dispensing operation or after the dispensing operation, and to determine the denomination and the number of money to be dispensed and dispense the money, on condition that the money storage ratio comes close to the reference ratio.

In a case where money of a certain sum is dispensed, when the number of money of the first denomination out of money stored in the storing unit is not less than the reference number or not less than the reference ratio, the control unit is configured to determine the denomination and the number of money to be dispensed such that the number of money to be dispensed is the least.

When a certain sum of money is dispensed, the control unit is configured to compare the money storage ratio to the reference ratio, and to determine the denomination and the number of money to be dispensed, on condition that the money storage ratio comes close to the reference ratio.

When a certain sum of money is dispensed, the control unit is configured to subtract the reference ratio of each denomination from the money storage ratio of each denomination before the dispensing operation, and to decide money to be dispensed by preferentially using the denomination whose subtraction result is the largest.

When a certain sum of money is dispensed, the control unit is configured to prepare a plurality of denomination patterns that indicate combinations of denominations of money to be dispensed, to compare the money storage ratio of each denomination to the reference ratio after the dispensing operation in the case that money is virtually dispensed according to each of the denomination patterns, to select one of the denomination patterns such that the money storage ratio comes close to the reference ratio, and to determine the denomination and the number of money to be dispensed based on the selected denomination pattern.

The money handling apparatus according to the present invention can reduce the number of operations for refilling money by controlling the denomination of money to be dispensed.

### BRIEF DESCRIPTION OF THE DRAWINGS

FIG. 1 is a block view showing a structural example of a money management system 1 according to a first embodiment.

FIG. 2 is a view showing an example of an appearance of a money settlement apparatus 11.

FIG. 3 is a block view showing a structural example of the money settlement apparatus 11.

FIG. 4 is a flowchart showing a method of determining the denomination pattern such that the number of money to be dispensed is the least.

FIG. 5 is a flowchart showing a method of determining the denomination pattern of money to be dispensed based on the reference number.

FIG. 6 is a conceptual view showing variation in the number of money stored in a storing unit 150 of the money settlement apparatus 11 according to the first embodiment.

FIG. 7 is a flowchart showing a dispensing operation of the money settlement apparatus 11 according to the first embodiment.

FIG. 8 is a table showing an example of set values of respective denominations and the actual numbers of stored money of respective denominations.

FIG. 9 is a flowchart showing a dispensing operation based on a reference ratio according to a second embodiment.

FIG. 10 is a view for explaining further in detail the dispensing operation based on a reference ratio.

FIG. 11 is a table showing an example of a plurality of dispensing patterns according to a modification of the second embodiment.

FIG. 12 is a flowchart showing a dispensing operation based on a reference ratio according to the modification of the second embodiment.

FIG. 13 is a flowchart showing a dispensing operation according to a third embodiment.

### BEST MODE FOR CARRYING OUT THE INVENTION

Embodiments of the present inventions will be described herebelow with reference to the drawings. These embodiments do not limit the present invention.

### First Embodiment

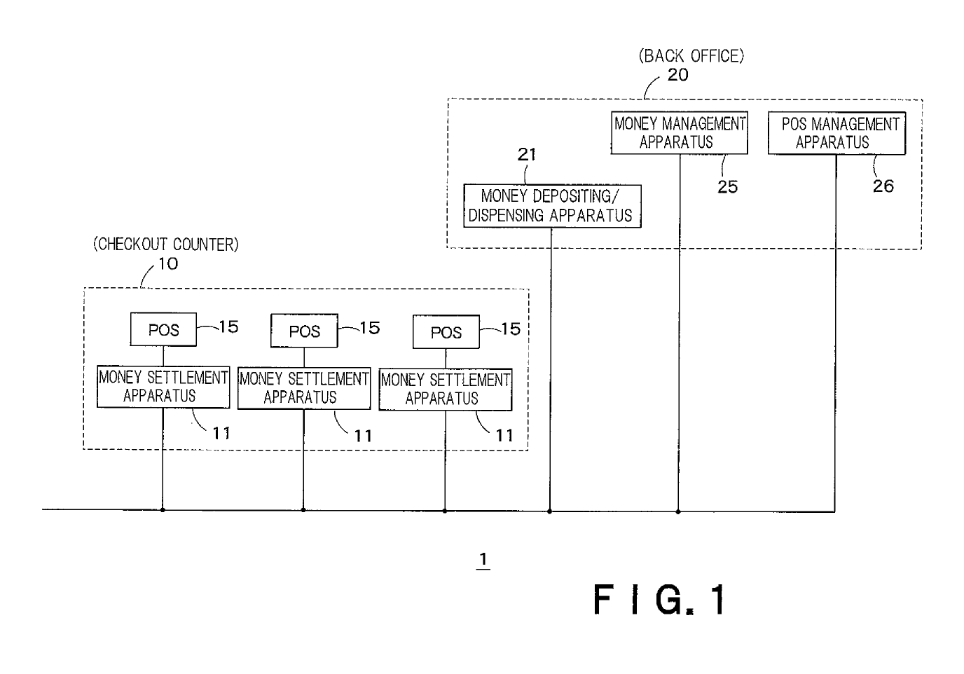

FIG. 1 is a block view showing a structural example of a money management system 1 according to a first embodiment of the present invention. The money management system 1 is a system that handles and manages money which has been received by a clerk from a customer and money which is to be paid by the clear to the customer.

The money management system 1 includes: a checkout counter 10 installed in a checkout area of a store and configured to deposit and dispense money which is received by a clerk from a customer or is paid from a clerk to a customer, and a back office 20 configured to manage money in the checkout counter 10 and commodities.

The checkout counter 10 is provided with one or a plurality of money settlement apparatus(es) 11 configured to perform a cash settlement process with respect to a customer by depositing and dispensing money. In FIG. 1, the checkout counter 10 has three money settlement apparatuses 11. The money settlement apparatus 11 as a money handling apparatus is operated by a clerk or a customer himself/herself so as to be used in a cash settlement process between the clerk and the customer. For example, the money settlement apparatus 11 deposits money paid by a customer or dispenses a change to be paid to the customer.

The money settlement apparatus 11 is connected with a POS register 15 operated by a clerk or a self-checkout register (not shown) operated by a customer so as to be able to communicate with each other. The money settlement apparatus 11 may be integrally formed with the POS register or the self-checkout register.

In the back office 20, there are provided a money depositing/dispensing apparatus 21, a money management apparatus 25 and a POS management apparatus 26. The money depositing/dispensing apparatus 21 is connected with the money settlement apparatuses 11 so as to be able to communicate with each other, and is configured to, for example, dispense a change fund to be loaded into the money settlement apparatus 11 or to deposit sales proceeds collected from the money settlement apparatus 11. The money management apparatus 25 is connected with the money settlement apparatuses 11 and the money depositing/dispensing apparatus 21 via a LAN (Local Area Network) so as to be able to communicate with each other. The money management apparatus 25 is configured to manage money stored in the money settlement apparatuses 11 and the money depositing/dispensing apparatus 21. For example, the money management apparatus 25 manages money which has been subjected to a cash settlement process in each of the money settlement apparatuses 11, and money transmitted between the money settlement apparatus 11 and the money depositing/dispensing apparatus 21. The POS management apparatus 26 is configured to manage a flow of commodities. Since the flow of commodities is not directly related to the present invention, detailed description of the POS management apparatus 26 is omitted herein.

<Structure of Money Settlement Apparatus 11>

Each of the money settlement apparatuses 11 includes a coin settlement apparatus 13 configured to perform a cash settlement process by depositing and dispensing a coin, and a banknote settlement apparatus 12 configured to perform a cash settlement process by depositing and dispensing a banknote.

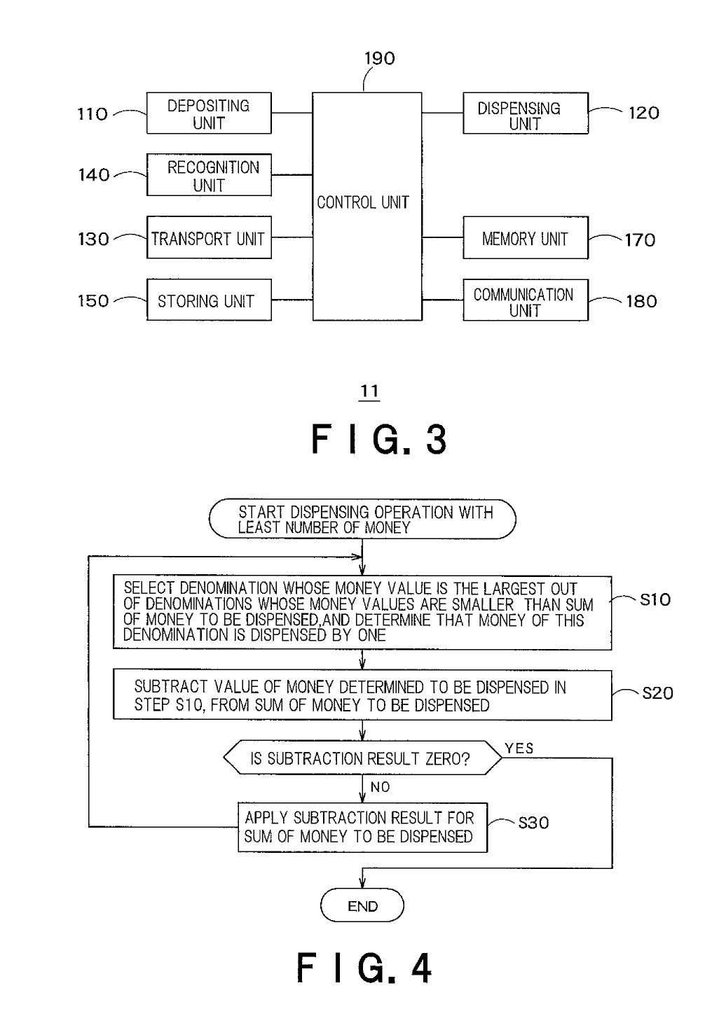

Herebelow, in order to differentiate a constituent element of the banknote settlement apparatus 12 and a constituent element of the coin settlement apparatus 13 from each other, the character “a” is added to each reference number of the constituent elements of the banknote settlement apparatus 12, and the character “b” is added to each reference number of the constituent elements of the coin settlement apparatus 13. Since objects to be handled by the coin settlement apparatus 13 and the banknote settlement apparatus 12 differ from each other, i.e., a coin and a banknote, the concrete structures of the coin settlement apparatus 13 and the banknote settlement apparatus 12 differ from each other. However, the coin settlement apparatus 13 and the banknote settlement apparatus 12 have similar basic block structure show in FIG. 3.

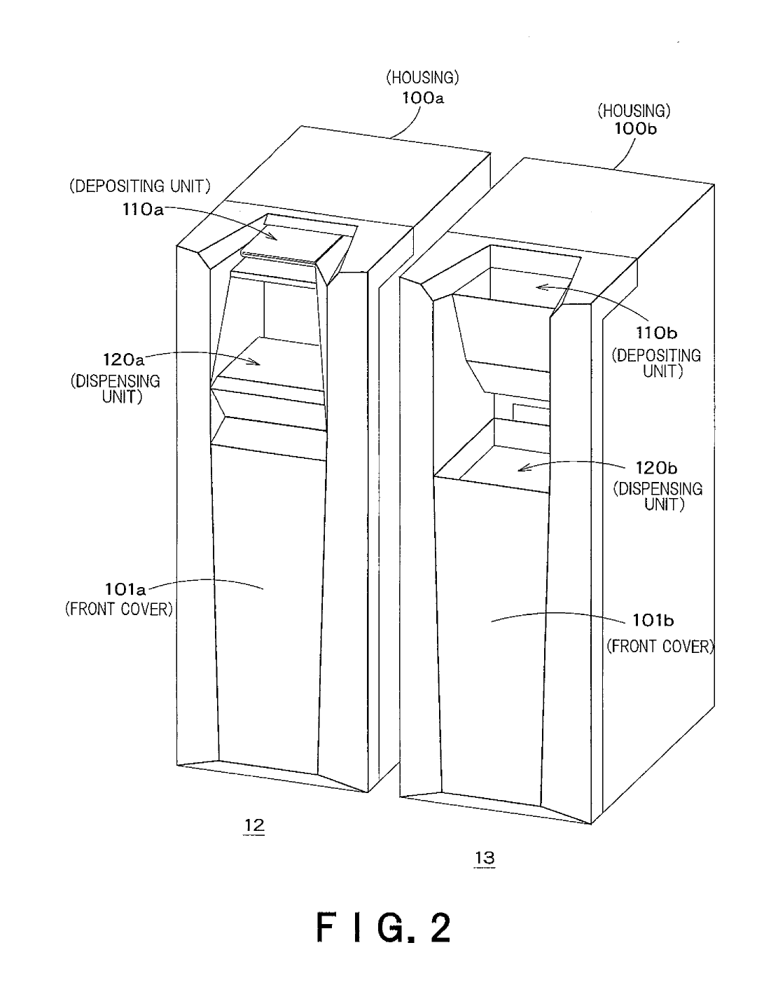

FIG. 2 is a view showing an example of an appearance of each money settlement apparatus 11. The money settlement apparatus 11 includes the banknote settlement apparatus 12 and the coin settlement apparatus 13. The banknote settlement apparatus 12 includes a housing 100a, a depositing unit 110a and a dispensing unit 120a. The depositing unit 110a is provided for putting a banknote received from a customer into the banknote settlement apparatus 12. The dispensing unit 120b is provided for dispensing a change banknote.

The coin settlement apparatus 13 includes a housing 100b, a depositing unit 110b and a dispensing unit 120b. The depositing unit 110b is provided for putting a coin received from a customer into the coin settlement apparatus 13. The dispensing unit 120b is provided for dispensing a change coin.

FIG. 3 is a block view showing a structural example of the money settlement apparatus 11. The money settlement apparatus 11 includes a transport unit 130, a recognition unit 140, a storing unit 150, a memory unit 170, a communication unit 180 and a control unit 190 as well as the depositing unit 110 and the dispensing unit 120.

The transport unit 130 is configured to transport money having been put through the depositing unit 110 to the storing unit 150, or to transport money from the storing unit 150 to be dispensed from the dispensing unit 120.

The recognition unit 140 is configured to detect denomination of money, authenticity of money, fitness of money, oldness of money, number of money, and so on, transported by the transport unit 130. For example, the recognition unit 140 is equipped with a sensor such as an image sensor or a magnetic sensor.

The storing unit 150 is configured to be capable of storing money, which has been recognized by the recognition unit 140, by denomination. When a banknote is stored, the storing unit 150 may be a stacking type storing unit for storing banknotes which are stacked by denomination, or a tape reeling type storing unit in which banknotes are sandwiched by denomination between a plurality of tapes, and in which the banknotes together with the tapes are reeled up.

The memory unit 170 includes a ROM (Read Only Memory) or a HDD (Hard Disk Drive) that stores various programs and data for controlling the money settlement apparatus 11, and a RAM (Random Access Memory) that is a program loading area or a work area when a program is executed. The memory unit 170 also stores data of the number of money stored in the storing unit 150 by denomination. In addition, the memory unit 170 stores data of the number of money, which has been deposited or dispensed and recognized by the recognition unit 140, by denomination.

Further, the memory unit 170 stores a reference value of each denomination relating to the number of money to be stored in the storing unit 150. The reference value is the reference number for each denomination, or a reference ratio of the number of money for each denomination.

The reference number is the reference number corresponding to the respective denominations of the money stored in the storing unit 150, and is set for each denomination. When the reference number is used as the reference value, a combination of denominations of money to be dispensed as a change (referred to also as “denomination pattern” herebelow) is determined based on a comparison between the number of money of each denomination stored in the storing unit 150 and the reference number of each corresponding denomination. For example, the money settlement apparatus 11 determines the denomination and the number of money to be dispensed, giving a priority to money of the denomination whose number of money actually stored in the storing unit 150 is larger than the reference number.

The reference ratio is a reference of a number ratio (stored ratio) of the number of stored money of a certain denomination relative to the number of stored money of a plurality of denominations. The reference ratio can be considered as a target value of a stored ratio of money, for each denomination, stored in the storing unit 150. When the reference ratio is used as the reference value, a denomination pattern of money to be dispensed as a change is determined based on a comparison between the stored ratio of each denomination and the reference ratio of each denomination. For example, the money settlement apparatus 11 determines the denomination and the number of money to be dispensed, giving a priority to money of a denomination whose stored ratio is larger than the reference ratio.

The communication unit 180 is connected with other apparatuses (the money depositing/dispensing apparatus 21, the money management apparatus 25 and the POS management apparatus 26) constituting the money management system 1 so as to be able to communicate with each other.

The control unit 190 is a processing unit configured to execute a program in the memory unit 170 so as to control the money settlement apparatus 11 as a whole. The control unit 190 controls the denomination and the number of money to be dispensed from the dispensing units 120a and 120b. For example, when money of a certain sum is dispensed, the control unit 190 determines the denomination and the number of money to be dispensed, giving a priority to money of a denomination whose number of stored money or stored ratio is larger than the reference value of the corresponding denomination.

A method of determining the denomination pattern of money to be dispensed will be described in detail herebelow.

(Dispense Money of the Least Number)

FIG. 4 is a flowchart showing a method of determining the denomination pattern such that money of the least number is to be dispensed. The control unit 190 of the money settlement apparatus 11 determines money to be dispensed such that the number of money to be dispensed becomes the least. Namely, the control unit 190 creates a denomination pattern by preferentially using money of a larger denomination, such that money of the least number is to be dispensed. For example, when 68 euro is dispensed, the control unit 190 creates a denomination pattern such that one 50 euro banknote, one 10 euro banknote, one 5 euro banknote, one 2 euro coin and one 1 euro coin are dispensed. Thus, the number of money to be dispensed becomes the least number (five).

More specifically, the control unit 190 selects a denomination that is the largest (e.g., 50 euro banknote) out of denominations whose money values are smaller than a sum of money to be dispensed (e.g., 68 euro), and determines that one banknote of this denomination is dispensed (510). As a matter of course, the denomination selected at this step is limited to a denomination that is dispensable. For example, since there is no possibility that the largest denomination (500 euro) out of the euro denominations is dispensed as a change, such a denomination is not selected in this step. In addition, a denomination of money that is not stored in the storing unit 150 is not selected.

Then, the control unit 190 subtracts the value of money, which has been determined to be dispensed in the step S10 (e.g., 50 euro), from the sum of money to be dispensed (e.g., euro) (S20). Then, the control unit 190 applies the subtraction result (e.g., 18 euro) to the sum of money to be dispensed (S30), and repeats the steps S10 and S20. Until a subtraction result becomes zero, the control unit 190 repeats the steps S10 and S20. Thus, the money settlement apparatus 11 can dispense money of the least number.

In the above example, the money settlement apparatus 11 determines that one 50 euro banknote is dispensed by performing the first steps S10 and S20, determines that one 10 euro banknote is dispensed by performing the next steps S10 and S20, determines that one 5 euro banknote is dispensed by performing the next steps S10 and S20, determines that one 2 euro coin is dispensed by performing the next steps S10 and S20, and determines that one 1 euro coin is dispensed by performing the next steps S10 and S20. Thus, the banknote settlement apparatus 11 can dispense 68 euro of the least number (five).

In the repetition of the steps S10 and S20, there is a case in which the control unit 190 selects the same denomination plural times. In this case, the money settlement apparatus 11 dispenses money of the same denomination such that the number of money of this denomination corresponds to the selected number.

(Dispense of Money Based on Reference number)

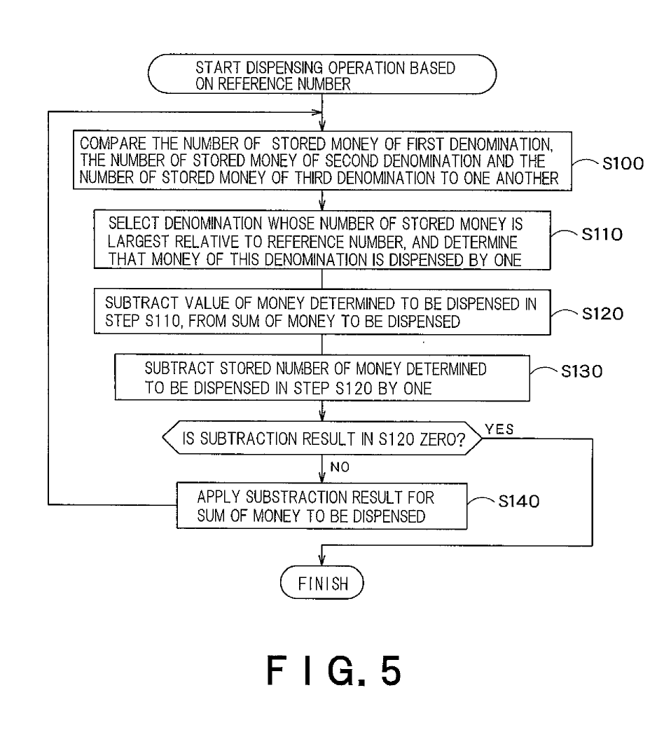

FIG. 5 is a flowchart showing a method of determining the denomination pattern of money to be dispensed based on the reference number. In this case, the control unit 190 determines the denomination and the number of money to be dispensed, by preferentially selecting money of a denomination whose number of money stored in the storing unit 150 is larger than the corresponding reference number.

Note that, in this embodiment, the numbers of stored money of three denominations are compared to one another. The three denominations include a first denomination that is the largest denomination out of denominations whose money values are smaller than a sum of money to be dispensed, a second denomination and a third denomination (two smaller denominations) whose money values are smaller than the first denomination. Namely, the control unit 190 compares, out of the numbers of money stored in the storing unit 150, the number of stored money of the first denomination, the number of stored money of the second denomination that is next smallest after the first denomination, and the number of stored money of the third denomination that is next smallest after the second denomination, to one another (S100).

For example, when 68 euro is dispensed, a 50 euro banknote, whose money value is the largest out of denominations whose money values are smaller than 68 euro, is a first denomination. Then, the numbers of stored money of three denominations (i.e., 50 euro banknote, 20 euro banknote and 10 euro banknote) are compared to one another. Namely, the number of the stored 50 euro banknote as the first denomination, the number of the stored 20 euro banknote whose money value is smaller than a 50 euro banknote and the number of the stored 10 euro banknote whose money value is smaller than 50 euro banknote are compared to one another. The control unit 190 selects a denomination whose number of stored money is the largest relative to the reference number, and determines that money of this denomination is dispensed by one (S110). For example, when the number of 10 euro banknotes stored in the storing unit 150 is 110, the number of 20 euro banknotes is 120, and the number of 50 euro banknote is 100, the number of 20 euro banknotes is the largest relative to the reference number. Thus, the control unit 190 selects one euro banknote, and determines that the one 20 euro banknote is dispensed.

Then, the control unit 190 subtracts the value of money (e.g., 20 euro) determined to be dispensed, from the sum of money to be dispensed (e.g., 68 euro) (S120). In addition, the control unit 190 reduces the number of stored money, which has been determined to be dispensed in the step S120, by one (S130). For example, when it is determined that one 20 euro banknote is dispensed, the control unit 190 reduces the number of stored 20 euro banknote by one. Namely, the number of stored 20 euro banknote becomes 119.

Then, the control unit 190 applies the subtraction result (e.g., 48 euro) in the step S120 to the sum of money to be dispensed (S140), and repeats the steps S100 to S130.

More specifically, a denomination that is the largest (e.g., 20 euro banknote) out of denominations whose money values are smaller than the sum of money to be dispensed (e.g., 48 euro) becomes a first denomination. Then, the number of stored 20 euro banknote as the first denomination, the number of stored 10 euro banknote as a second denomination, and the number of stored 5 euro banknote as a third denomination are compared to one another. Then, the control unit 190 selects a denomination whose number of stored money is the largest relative to the reference number, out of the three denominations, and determines that one banknote of this denomination is dispensed (S110). Herein, the control unit 190 again selects a 20 euro banknote, and determines that one 20 euro banknote is dispensed.

Then, the control unit 190 subtracts the sum of money determined to be dispensed (e.g., 20 euro), from the sum of money to be dispensed (e.g., 48 euro) (S120). In addition, the control unit 190 reduces the number of stored 20 euro banknote, which has been determined to be dispensed, by one (S130). Namely, the number of stored 20 euro banknote becomes 118.

Then, the control unit 190 applies the subtraction result (e.g., 28 euro) in the step S120 to the sum of the money to be dispensed (S140), and repeats the steps S100 to S130 again.

Until the subtraction result in the step S120 becomes zero, the control unit 190 repeats the above steps. Thus, the money settlement apparatus 11 can determine denominations of money to be dispensed such that stored quantities of money of the respective denominations come close to the reference number.

After such a dispensing operation has been repeated, the numbers of stored money of the respective denominations decrease, and reach the reference number (e.g., 100). In the embodiment, for example, when the number of money of one denomination stored in the storing unit 150 reaches the reference number, the control unit 190 may change the reference number. Alternatively, when the number of money of a plurality of denominations stored in the storing unit 150 reach the reference value, the control unit 190 may change the reference number. In this case, the control unit 190 may change the reference value, when the numbers of money of the three denominations, which have been selected in the step S100, reach the reference number.

When the reference number is changed, the control unit 190 uses, as the reference number, the second reference number that is smaller than the first reference number which has been firstly used in the dispensing operation. The first and second reference numbers are stored in the memory unit 170 in advance, as a reference value to be firstly used in the dispensing operation and a reference value to be used when the number of money stored in the storing unit 150 decreases, respectively.

In the above example, although the reference numbers of the respective denominations are the same one, the reference number may differ for each denomination. When the reference numbers of the respective denominations are the same, the control unit 190 may merely compare the numbers of stored money of the respective denominations in the step S100. Namely, it is not necessary to compare the number of stored money with the reference number. However, when the reference number differs depending on the denominations, it is necessary for the control unit 190 to compare the numbers of stored money and the reference numbers in the step S100. In addition, in the above example, the control unit 190 compares the respective numbers of stored money of the first denomination and the two denominations smaller than the first denomination (two smaller denominations). However, the control unit 190 may compare the number of stored money of the first denomination and the number of stored money of one smaller denomination to each other. Alternatively, the control unit 190 may compare the respective numbers of stored money of the first denomination and three smaller denominations to one another.

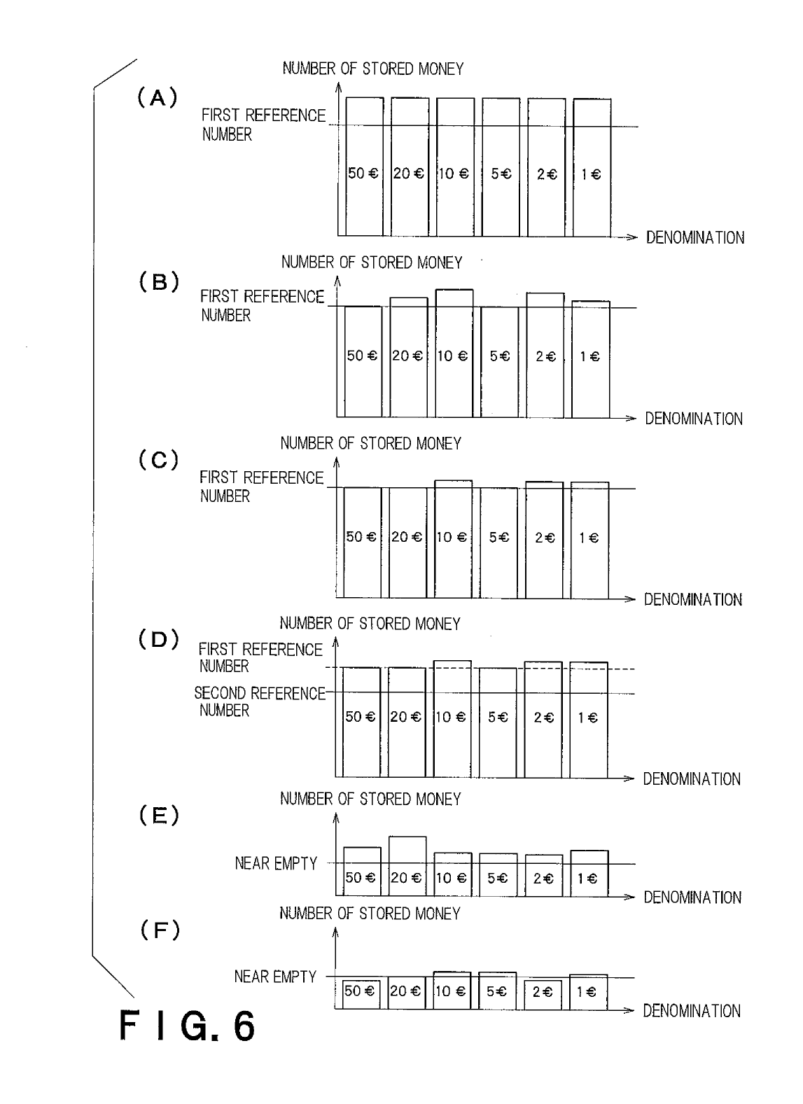

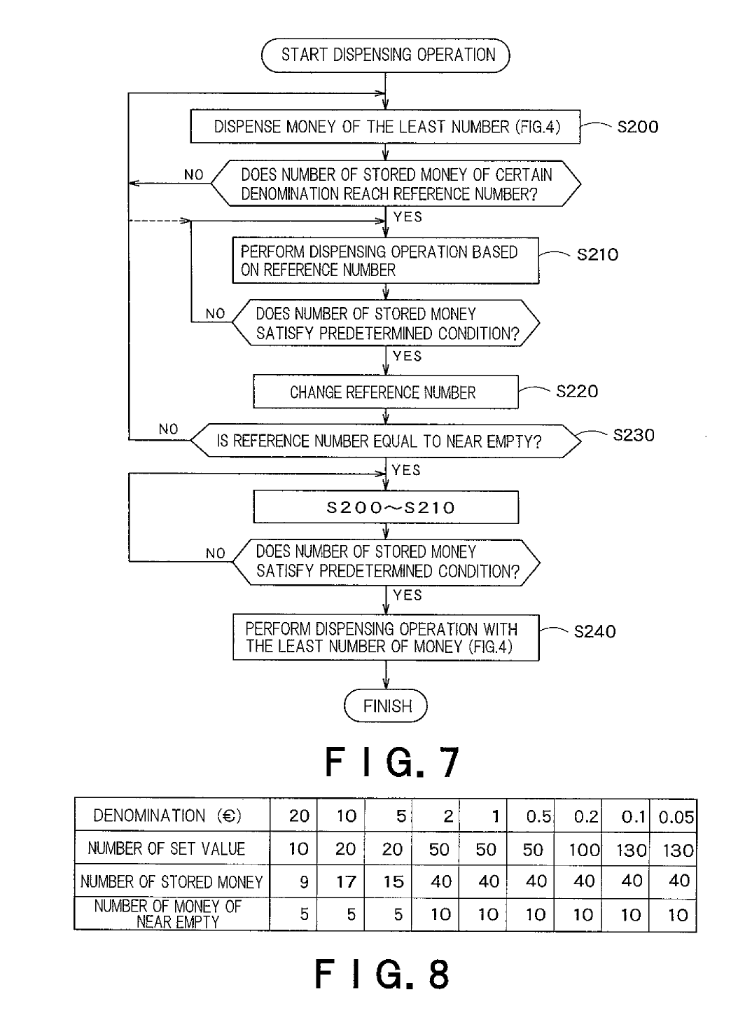

FIGS. 6A to 6F are conceptual views showing variation in number of money stored in the storing unit 150. FIG. 7 is a flowchart showing a dispensing operation of the money settlement apparatus 11 according to the first embodiment.

For example, as shown in FIG. 6A, when a store opens, the numbers of stored money of the all denominations are larger than the first reference number. At this time, the control unit 190 performs the dispensing operation with money of the least number which is shown in FIG. 4. Thus, the money settlement apparatus 11 dispenses money of the least number (S200).

As the dispensing operation with money of the least number continues, the number of stored money of a certain denomination decreases. When the number of stored money of this denomination reaches the first reference number, the control unit 190 performs the dispensing operation based on the reference number which is shown in FIG. 5 (S210). For example, as shown in FIG. 6B, suppose that the respective numbers of stored 50 euro banknote and 5 euro banknote in the storing unit 150 reach the first reference number. In this case, the money settlement apparatus 11 dispenses money by using a 20 euro banknote or a 10 euro banknote whose money values are smaller than a 50 euro banknote, instead of using a 50 euro banknote, when a 50 euro banknote is the first denomination. In addition, the money settlement apparatus 11 dispenses money by using a 2 euro coin or a 1 euro coin whose money values are smaller than a 5 euro banknote, instead of using a 5 euro banknote, when a 5 euro banknote is the first denomination. Thus, the money settlement apparatus 11 can suppress decrease in numbers of stored 50 euro banknote and 5 euro banknote, so that the numbers of stored money of the respective denominations can come close to the first reference number corresponding to each denomination. That is to say, the control settlement apparatus 11 performs the dispensing operation based on the reference number, whereby it can be prevented that the number of stored money of a specified denomination significantly deviates from the reference number and extremely decreases. Thus, since the money settlement apparatus 11 performs the dispensing operation while controlling the numbers of stored money of the respective denominations, the number of operations for refilling the money settlement apparatus 11 with money can be reduced.

Then, when the number of stored money satisfies a predetermined condition, the control unit 190 changes the first reference number to the second reference number that is smaller than the first reference number (S220). The predetermined condition may be considered to be a case in which the numbers of stored money of the predetermined number of denominations, out of the denominations of the money stored in the storing unit 150, reach the first reference number, or a case in which the number of stored money of a certain denomination reaches a number of “near-empty” of the corresponding denomination. For example, as shown in FIG. 6C, when the numbers of stored money of three denominations (50 euro banknote, 20 euro banknote and 5 euro banknote) out of the denominations of the money stored in the storing unit 150 reach the first reference number, the control unit 190 changes the first reference number to the second reference number, as shown in FIG. 6D.

Thereafter, the control unit 190 performs the dispensing operation with money of the least number (FIG. 4) or the dispensing operation based on the second reference number (FIG. 5). At this time, the control unit 190 may return the process to the step S200 so as to perform the dispensing operation with money of the least number (FIG. 4). Alternatively, the control unit 190 may return the process to the step S210 so as to perform the dispensing operation based on the second reference number (FIG. 5).

In a case where the third reference number that is smaller than the second reference number is stored in the memory unit 170, when the numbers of stored money of three denominations out of the denominations of the money stored in the storing unit 150 reach the second reference number, for example, the control unit 190 may change the second reference number to the third reference number. Further, for each time when the aforementioned predetermined condition is fulfilled, the control unit 190 may perform the dispensing operation with the use of the reference number succeeding to the fourth reference number.

After that, as shown in FIG. 6E, when the reference number becomes equal to the “near empty” (YES in S230), the control unit 190 does not need to lower the reference number any more thereafter. Then, after the dispensing operation with money of the least number (step S200) and the dispensing operation based on the reference number (step S210) have been performed, when the numbers of stored money of the predetermined number of denominations (e.g., 3 denominations) out of the denominations of the money stored in the storing unit 150 reach the “near empty”, the control unit 190 continues the dispensing operation based on the reference number (step S210) or performs the dispensing operation with money of the least number (step S200) (S240). Further, the control unit 190 may perform the below-described dispensing operation based on the reference ratio. Herein, “near empty” means that the number of stored money of a certain denomination in the storing unit 150 is close to zero, and the number of stored money indicating the “near empty” is preset and stored in the memory unit 170. Thus, when the reference number becomes equal to the “near empty”, or when the numbers of stored money of the predetermined number of denominations reach the “near empty”, a clerk of the store requests refilling of money to an armoured car company or the like.

As described above, according to this embodiment, when the number of stored money of the first denomination out of the money stored in the storing unit 150 reaches the reference number, and the number of stored money of the denomination smaller than the first denomination is not less than the reference number, the control unit 190 determines the denomination and the number of money to be dispensed, by giving priority to the smaller denomination. Thus, the money settlement apparatus 11 can control the denominations of money to be dispensed such that the numbers of stored money of the respective denominations do not deviate from the reference number.

Further, when the number of money stored in the storing unit 150 satisfies the above predetermined condition, the control unit 190 changes the reference number. In this manner, the money settlement apparatus 11 can control the process while changing the reference number, such that the numbers of stored money of the respective denominations come close to the reference number up to the “near empty”. Thus, the money settlement apparatus 11 can reduce the number of operations for refilling money.

### Second Embodiment

In a second embodiment, the control unit 190 compares a reference ratio and a money storage ratio before the dispensing operation and after the dispensing operation, and determines the denomination and the number of money to be dispensed on condition that the money storage ratio comes close to the reference ratio after the dispensing operation.

The money storage ratio is a ratio of the number of stored money of each denomination relative to the total number of stored money of a plurality of denominations stored in the storing unit 150. For example, when the money storage ratio is calculated by three denominations, the control unit 190 calculates the money storage ratio by using the numbers of stored money of the three denominations including a first denomination which is the largest denomination among denominations whose money values are smaller than a sum of money to be dispensed, and a second denomination and a third denomination (two smaller denominations) whose money values are smaller than the first denomination. The number of stored money of a certain denomination out of the first to third denominations is divided by a total sum of the numbers of stored money of the first to third denominations to obtain the money storage ratio. For example, suppose that the number of stored 20 euro banknote is 9, the number of stored 10 euro banknote is 17 and the number of stored 5 euro banknote is 15. In this case, the money storage ratio of 20 euro banknote is about 22% (9/(9+17+15) substantially equals to 0.220). The money storage ratio of 10 euro banknote is about 41.5% (17/(9+17+15) substantially equals to 0.415). The money storage ratio of 5 euro banknote is about 36.5% (15/(9+17+15) substantially equals to 0.365).

The reference ratio is a ratio of a set value of each denomination relative to a total sum of set values that are preset for the numbers of stored money of a plurality of denominations. The set value is a number of stored money to be remained in the storing unit 150, which may be the same as the reference number in the first embodiment or a change fund. The reference ratio is a target value of the money storage ratio of each denomination, and is stored in the memory unit 170 in advance. For example, suppose that a set value (number) of 20 euro banknote is 10, a set value (number) of 10 euro banknote is 20, and a set value (number) of 5 euro banknote is 20. In this case, the reference ratio of 20 euro banknote is 20% (10/(10+20+20) equals to 0.2). The reference ratio of 10 euro banknote is 40% (20/(10+20+20) equals to 0.4). The reference ratio of 5 euro banknote is 40% (20/(10+20+20) equals to 0.4).

The control unit 190 determines the denomination pattern of money to be dispensed such that the money storage ratios of the respective denominations come close to the corresponding reference ratios.

(Dispense of Money Based on Reference Ratio)

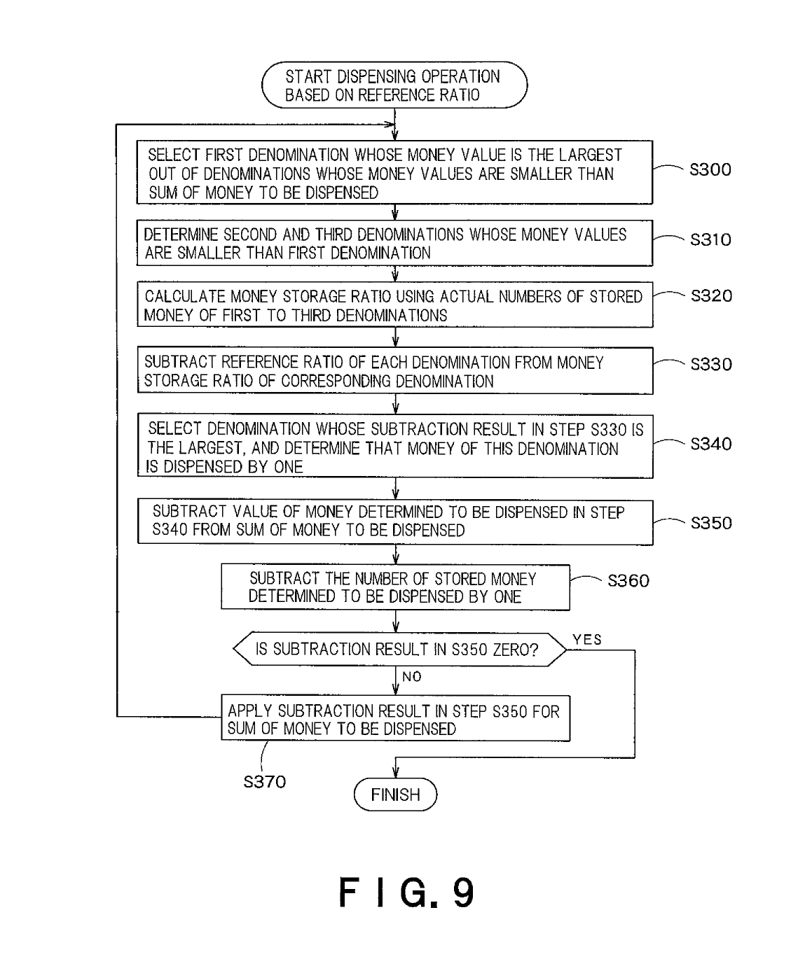

FIG. 8 is a table showing an example of set values of the respective denominations and the numbers of actually stored money thereof. FIG. 9 is a flowchart showing the dispensing operation based on the reference ratio according to the second embodiment.

Firstly, the control unit 190 selects, as a first denomination, a denomination whose money value is the largest out of denominations whose money values are smaller than a sum of money to be dispensed (S300). As a matter of course, the denomination selected in this step is limited to a denomination that is dispensable. Herein, the money settlement apparatus 11 stores money ranging from 20 euro banknote to 5 cent coin, and is configured to be capable of dispensing the money stored therein. For example, when 68 euro is dispensed, the control unit 190 selects 20 euro banknote as the first denomination.

Then, the control unit 190 determines a second denomination and a third denomination whose money values are smaller than the first denomination (two smaller denominations) (S310). For example, when 20 euro banknote is the first denomination, the second and third denominations are 10 euro banknote and 5 euro banknote.

Then, the control unit 190 calculates money storage ratios by using the numbers of actually stored money of the first to third denominations (S320). For example, as shown in FIG. 8, when the respective numbers of stored money of 20 euro banknote, 10 euro banknote and 5 euro banknote are 9, 17 and 15, respectively, the money storage ratios of 20 euro banknote, 10 euro banknote and 5 euro banknote are about 22%, about 41.5% and about 36.5%, respectively, as described above.

In addition, the set values of 20 euro banknote, 10 euro banknote and 5 euro banknote are 10, 20 and 20, respectively. Thus, as described above, the reference ratios of 20 euro banknote, 10 euro banknote and 5 euro banknote are 20%, 40% and 40%, respectively.

Then, the control unit 190 determines that money is dispensed by preferentially using the denomination whose money storage ratio is the largest relative to the reference ratio. Namely, the control unit 190 subtracts the reference ratios of the respective denominations, from the money storage ratios of the corresponding denominations (S330), selects the denomination whose subtraction result is the largest, and determines that money of this denomination is dispensed by one (S340). For example, the control unit 190 subtracts the reference ratio of 20 euro banknote (20%), from the money storage ratio of 20 euro banknote (22%). The subtraction result is 2%. The control unit 190 subtracts the reference ratio of 10 euro banknote (40%), from the money storage ratio of 10 euro banknote (41.5%). The subtraction result is 1.5%. The control unit 190 subtracts the reference ratio of 5 euro banknote (40%), from the money storage ratio of 5 euro banknote (36.5%). The subtraction result is −3.5%. From these subtraction results, it can be understood that the money storage ratio of 20 euro banknote most exceeds the reference ratio of the corresponding denomination, as compared with the money storage ratios of the other two denominations. This means that the number of stored 20 euro banknote can most afford relative to the set value, as compared with the other two denominations. Thus, the control unit 190 determines that one 20 euro banknote is dispensed. When there are a plurality of denominations whose subtraction results are the same with each other and larger than another subtraction result in the step S330, the control unit 190 may select a denomination whose money value is larger.

Then, the control unit 190 subtracts the value of money determined to be dispensed in the step S340, from the sum of money to be dispensed (e.g., 68 euro) (5350). In addition, the control unit 190 reduces the number of the stored money determined to be dispensed by one (S360). At this time, the number of stored 20 euro banknote is 8, which is obtained by subtracting one from nine.

Then, the control unit 190 applies the subtraction result in the step S350 (e.g., 48 euro) to the sum of money to be dispensed (S370), and repeats the steps S300 to S370. The control unit 190 repeats the steps S300 to S370 until the subtraction result in the step S350 becomes zero. Thus, the money settlement apparatus 11 can dispense money that is constituted by the denomination pattern determined based on the reference ratio.

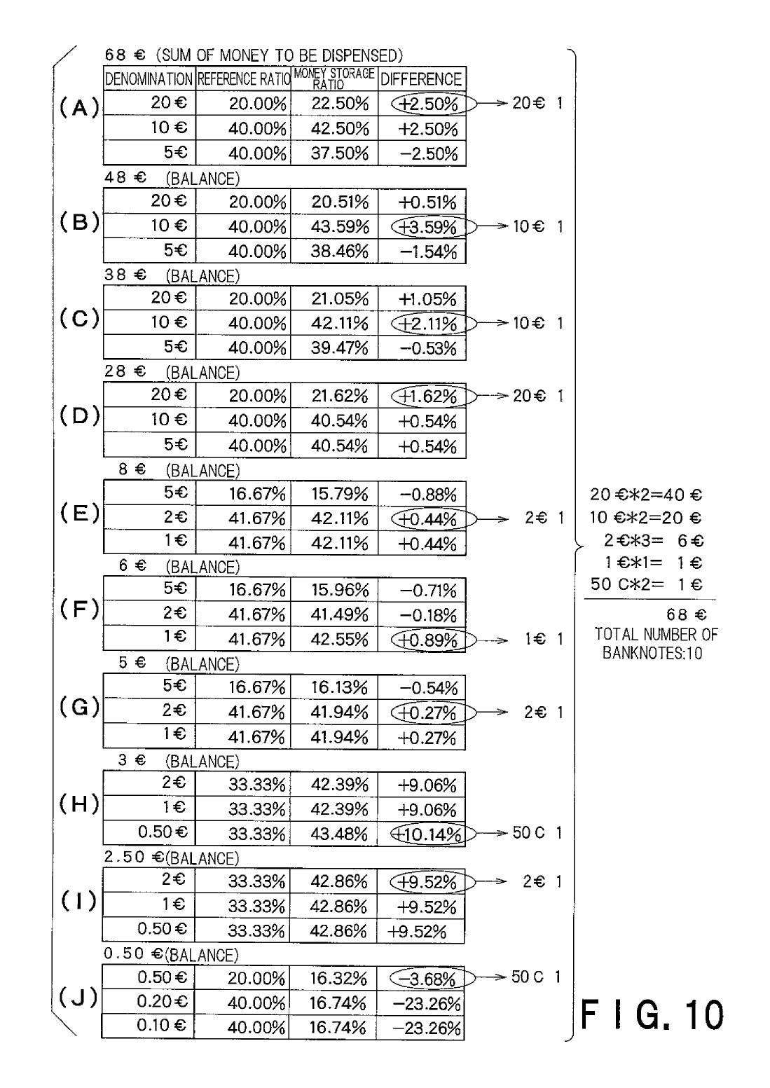

FIG. 10 is a view showing the dispensing operation based on the reference ratio in more detail. FIGS. 10A to 10J are tables each showing the reference ratio, the money storage ratio and a difference between the money storage ratio and the reference ratio (i.e., the subtraction result in the step S330) of each of the first to third denominations.

As shown in FIG. 10A, 68 euro is a sum to be dispensed. When the steps S300 to S360 shown in FIG. 9 are performed once, 20 euro banknote, 10 euro banknote and 5 euro banknote are determined as the first to third denominations, and each difference between the money storage ratio and the reference ratio is calculated. In the example shown in FIG. 10A, the difference between the money storage ratio of 20 euro banknote and the corresponding reference ratio, and the difference between the money storage ratio of 10 banknote and the corresponding reference ratio, are equal to each other. In this case, the control unit 190 selects 20 euro banknote whose money value is larger, and determines that one 20 euro banknote is dispensed.

Then, when the steps S300 to 360 are performed, the remaining sum is 48 euro, and the number of stored 20 euro banknote determined to be dispensed is reduced by one. Thus, as shown in FIG. 10B, the remaining sum and the money storage ratios of the respective denominations vary. With the use of the remaining sum and the money storage ratios of the respective denominations, the steps S300 to S360 shown in FIG. 9 are again performed. Thus, the control unit 190 selects 10 euro banknote whose difference between the money storage ratio and the reference ratio is the largest, and determines that one 10 euro banknote is dispensed.

Then, when the steps S300 to S360 are performed, the remaining sum is 38 euro, and the stored money number of 10 euro banknote determined to be dispensed is reduced by one. Thus, as shown in FIG. 10C, the remaining sum and the money storage ratios of the respective denominations vary. With the use of the remaining sum and the money storage ratios of the respective denominations, the steps S300 to S360 shown in FIG. 9 are again performed. Thus, the control unit 190 selects 10 euro banknote whose difference between the money storage ratio and the reference ratio is the largest, and determines that one 10 euro banknote is dispensed.

Then, when the steps S300 to S360 are performed, the remaining sum is 28 euro, and the number of stored 10 euro banknote determined to be dispensed is reduced by one. Thus, as shown in FIG. 10D, the remaining sum and the money storage ratios of the respective denominations vary. With the use of the remaining sum and the money storage ratios of the respective denominations, the steps S300 to S360 shown in FIG. 9 are again performed. Thus, the control unit 190 selects 20 euro banknote whose difference between the money storage ratio ad the reference ratio is the largest, and determines that one 20 euro banknote is dispensed.

Then, when the steps S300 to S360 are performed, the remaining sum is 8 euro, and the number of stored 20 euro banknote determined to be dispensed is reduced by one. As shown in FIG. 10E, since the remaining sum is 8 euro, the control unit selects 5 euro banknote, 2 euro coin and 1 euro coin as the first to third denominations. Then, the control unit 190 again performs the steps S300 to S360 shown in FIG. 9. Thus, the control unit 190 selects 2 euro coin whose difference between the money storage ratio and the reference ratio is the largest and whose money value is larger, and determines that one 2 euro coin is dispensed.

Until the remaining sum becomes zero, the control unit 190 repeats the steps S300 to S360, and determines money to be dispensed one by one (FIGS. 10F to 103). Thus, the 68 euro to be dispensed is constituted by two 20 euro banknotes, two 10 euro banknotes, three 2 euro coins, one 1 euro coin and two 50 cent coins. In this manner, the denominations and the number of money to be dispensed are determined, and the money settlement apparatus 11 dispenses money according to the determination.

According to the second embodiment, the control unit 190 compares the money storage ratios of money of the respective denominations stored in the storing unit 150 and the corresponding reference ratios, and determines the denomination and the number of money to be dispensed such that the money storage ratio comes close to the corresponding reference ratio. Thus, the money settlement apparatus 11 can control the denominations of the money to be dispensed such that the money storage ratios of money of the respective denominations do not deviate from the corresponding reference ratios. As a result, the money settlement apparatus 11 can control the stored quantities of the respective denominations, and can suppress the number of operations for refilling money.

Similarly to the reference number in the first embodiment, the reference ratio may be changed when a predetermined condition is satisfied. That is to say, when the dispensing operation is firstly performed by using the first reference ratio and thereafter a predetermined condition is fulfilled, the control unit 190 may change the first reference ratio to the second reference ratio and perform the dispensing operation. The predetermined condition is considered to be, for example, a case in which the number of stored money of a certain denomination reaches the number of “near-empty” of the corresponding denomination shown in FIG. 8.

In order to change the reference ratio, the set value is changed. For example, the control unit 190 may calculate the second reference ratio by using the number of “near-empty” of each denomination as the set value. Thus, when the numbers of stored money of the respective denominations are larger than the corresponding numbers of “near empty”, the control unit 190 determines the denomination and the number of money to be dispensed by using the first reference ratio. Then, when the number of stored money of a certain denomination reaches the corresponding number of “near empty”, the control unit 190 determines the denomination and the number of money to be dispensed by using the second reference ratio. The first reference ratio and the second reference ratio may be stored in the memory unit 170 in advance.

Since the reference ratio can be changed, the money settlement apparatus 11 can control the numbers of stored money of respective denominations while changing the reference ratio up to the “near empty”. Thus, the money settlement apparatus 11 can reduce the number of operations for refilling money.

(Modification of Second Embodiment)

In the above second embodiment, the steps S300 to S360 are repeated so as to determine money to be dispensed one by one. However, in the following modification, the control unit 190 prepares a plurality of denomination patterns showing combinations of denominations of money to be dispensed, and compares the money storage ratio of each denomination to the corresponding reference ratio after the dispensing operation on the assumption that money is dispensed according to the respective denomination patterns. Then, the control unit 190 selects one of the denomination patterns such that the money storage ratio comes close to the reference ratio.

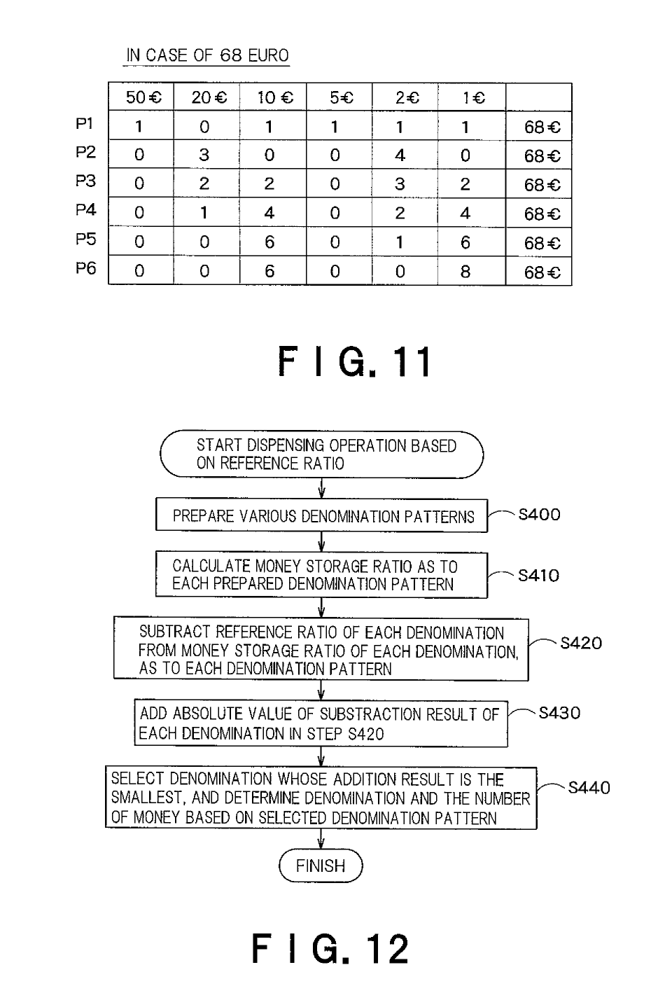

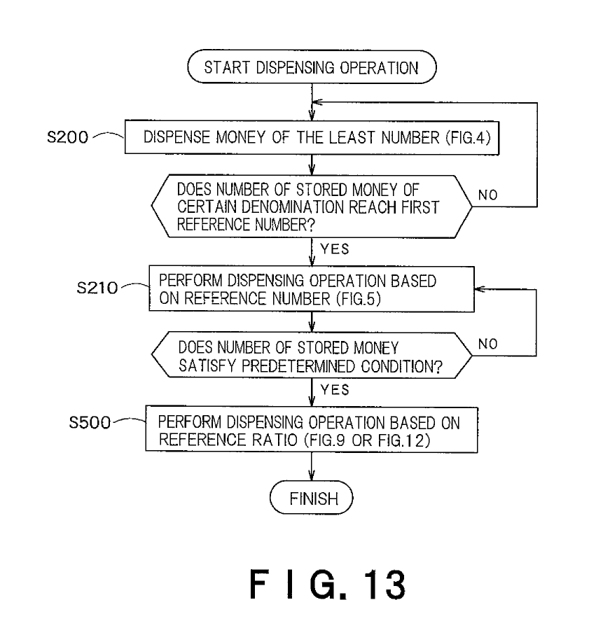

FIG. 11 is a table showing an example of a plurality of denomination patterns according to the modification of the second embodiment. FIG. 12 is a flowchart shown the dispensing operation based on the reference ratio according to the modification of the second embodiment.

For example, when 68 euro is dispensed, the control unit 190 prepares various denomination patterns showing denominations constituting 68 euro (S400). All of the denomination patterns P1 to P6 shown in FIG. 11 constitute money of 68 euro in total. The denomination patterns P1 to P6 shown in FIG. 11 are assumed as denomination patterns including one of first to third denominations. The denomination pattern 1 is a pattern of the least number of money. The control unit 190 may prepare variously other denomination patterns.

Then, the control unit 190 calculates the money storage ratios for all the prepared denomination patterns (S410). For example, on the assumption that money is dispensed according to the denomination pattern P1, the control unit 190 reduces the respective numbers of stored 50 euro banknote, 10 euro banknote, 5 euro banknote, 2 euro coin and 1 euro coin by one, respectively, and calculates the money storage ratios by using the numbers of stored money of the respective denominations after the subtraction. At this time, the money storage ratio may be a ratio of the number of stored money of each denomination relative to the numbers of stored money of all the denominations ranging from 50 euro banknote to 1 euro coin. In this case, the reference ratio is a ratio of the set value of each denomination relative to the set values of all the denominations ranging from 50 euro banknote to 1 euro coin. As to the denomination patterns P2 to P6, the control unit 190 similarly calculates the money storage ratios.

Then, as to the respective denomination patterns, the control unit 190 subtracts the reference ratio of each denomination, from the money storage ratio of the corresponding denomination (S420). For example, as to the denomination pattern P1, the control unit 190 subtracts the reference ratio of each denomination, from the money storage ratio of the corresponding denomination. As to the denomination patterns P2 to P6, the control unit 190 similarly subtracts the reference ratio of each denomination, from the money storage ratio of the corresponding denomination.

Then, the control unit 190 adds absolute values of the subtraction results of the respective denominations in the step S420 (S430). Namely, as to the respective denomination patterns P1 to P6, the control unit 190 evaluates a difference between the money storage ratio of each denomination and the reference ratio of the corresponding denomination. To be specific, as to the respective denomination patterns P1 to P6, the control unit 190 adds an absolute value of the difference between the money storage ratio of each denomination and the reference value of the corresponding denomination. As to the respective denomination patterns P1 to P6, the control unit 190 may add a square of the difference between the money storage ratio of each denomination and the reference ratio of the corresponding denomination. When the addition result is smallest, it can be said that the money storage ratio after the dispensing operation comes closest to the reference ratio. Thus, the control unit 190 compares the addition results of the denomination patterns P1 to P6, which have been calculated in the step S430, and selects the denomination pattern whose addition result is smallest. Based on the selected denomination pattern, the control unit 190 determines the denomination and the number of money (S440).

As shown in the modification, the control unit 190 may prepare a plurality of denomination patterns, select a denomination pattern by which the money storage ratio comes closest to the reference ratio, and determine the denomination and the number of money to be dispensed based on the selected denomination pattern. Also in this modification, the money settlement apparatus 11 can control denominations of money to be dispensed such that the money storage ratios of the respective denominations do not deviate from the corresponding reference ratios. As a result, this modification can provide the same effect as that of the second embodiment.

### Third Embodiment

In a third embodiment, the control unit 190 firstly determines the denomination and the number of money to be dispensed by using the reference number. Then, after the number of stored money has satisfied a predetermined condition, the control unit 190 determines the denomination and the number of money to be dispensed by using the reference ratio. Namely, the third embodiment is a combination of the first embodiment and the second embodiment. In this case, the memory unit 170 stores both the reference number and the reference ratio in advance.

FIG. 13 is a flowchart showing the dispensing operation according to the third embodiment. For example, as shown in FIG. 6A to 6C, the dispensing operation with money of the least number according to the first embodiment (FIG. 4) and the dispensing operation based on the reference numbers (FIG. 5) are performed. Namely, the steps S200 to S210 shown in FIG. 7 are performed.

Then, when the number of stored money of the storing unit 150 satisfies the aforementioned predetermined condition, the dispensing operation based on the reference ratio is performed (FIG. 9 or FIG. 12) (S500).

In this manner, the first embodiment and the second embodiment may be combined with each other. Thus, the third embodiment can provide the same effect as that of the first or second embodiment.

Not limited to the above embodiments, the dispensing operation with money of the least number, the dispensing operation based on the reference number and the dispensing operation based on the reference ratio may be optionally combined with each other.

1. A money handling apparatus comprising:
a storing unit configured to store money by denomination and to feed out money stored therein;
a dispensing unit configured to dispense money stored in the storing unit;
a memory unit configured to store data of a number of money of each denomination stored in the storing unit, and a reference value relating to the number of money to be stored for each denomination; and
a control unit configured to control the denomination and the number of money to be dispensed from the dispensing unit;
wherein:
the memory unit is configured to store plural sets of reference numbers which are numbers of money by denomination as the reference value, or a reference ratio which is a ratio of the number of money by denomination as the reference value; and
when a certain sum of money is dispensed, the control unit is configured to determine the denomination and the number of money to be dispensed, giving a priority to the denomination whose number of stored money or money storage ratio is larger than one of the reference numbers or the reference ratio, the money storage ratio being a ratio of stored money of each denomination relative to the numbers of money of a plurality of denominations stored in the storing unit, and
the dispensing unit dispenses the money determined by the control unit.

2. The money handling apparatus according to claim 1, wherein:
the memory unit is configured to store at least a first reference number which is firstly used as the reference value and a second reference number which is used when the number of money stored in the storing unit decreases;
in a case where a certain sum of money is dispensed, when the number of money of the first denomination out of money stored in the storing unit reaches the reference number and the number of money of a smaller denomination whose money value is smaller than the first denomination is larger than the reference number, the control unit is configured to determine the denomination and the number of money to be dispensed, giving a priority to the smaller denomination; and
when the number of money stored in the storing unit satisfies a predetermined condition, the control unit is configured to change the reference value from the first reference number to the second reference number.

3. The money handling apparatus according to claim 1, wherein:
the memory unit is configured to store the reference number and the reference ratio,
in a case where a certain sum of money is dispensed, when the number of money of the first denomination out of money stored in the storing unit reaches the reference number and the number of money of a smaller denomination whose money value is smaller than the first denomination is larger than the reference number, the control unit is configured to determine the denomination and the number of money to be dispensed, giving a priority to the smaller denomination; and
when the number of money stored in the storing unit satisfies a predetermined condition, the control unit is configured to compare the money storage ratio to the reference ratio before the dispensing operation or after the dispensing operation, and to determine the denomination and the number of money to be dispensed and dispense the money, on condition that the money storage ratio comes close to the reference ratio.

4. The money handling apparatus according to claim 2, wherein
in a case where money of a certain sum is dispensed, when the number of money of the first denomination out of money stored in the storing unit is not less than the reference number or not less than the reference ratio, the control unit is configured to determine the denomination and the number of money to be dispensed such that the number of money to be dispensed is the least.

5. The money handling apparatus according to claim 3, wherein
in a case where money of a certain sum is dispensed, when the number of money of the first denomination out of money stored in the storing unit is not less than the reference number or not less than the reference ratio, the control unit is configured to determine the denomination and the number of money to be dispensed such that the number of money to be dispensed is the least.

6. The money handling apparatus according to claim 1, wherein
when a certain sum of money is dispensed, the control unit is configured to compare the money storage ratio to the reference ratio, and to determine the denomination and the number of money to be dispensed, on condition that the money storage ratio comes close to the reference ratio.

7. The money handling apparatus according to claim 6, wherein
when a certain sum of money is dispensed, the control unit is configured to subtract the reference ratio of each denomination from the money storage ratio of each denomination before the dispensing operation, and to decide money to be dispensed by preferentially using the denomination whose subtraction result is the largest.

8. The money handling apparatus according to claim 6, wherein
when a certain sum of money is dispensed, the control unit is configured to prepare a plurality of denomination patterns that indicate combinations of denominations of money to be dispensed, to compare the money storage ratio of each denomination to the reference ratio after the dispensing operation in the case that money is virtually dispensed according to each of the denomination patterns, to select one of the denomination patterns such that the money storage ratio comes close to the reference ratio, and to determine the denomination and the number of money to be dispensed based on the selected denomination pattern.
